(19) United States
(12) Patent Application Publication
(10) Pub. No.: US 2017/0355631 A1
(43) Pub. Date: Dec. 14, 2017

(54) BIOGAS COGENERATION SYSTEMS

(71) Applicant: Universal Blower Pac, Inc., Noblesville, IN (US)

(72) Inventor: Andrew Placek, Noblesville, IN (US)

(21) Appl. No.: 15/176,918

(22) Filed: Jun. 8, 2016

(51) Int. Cl. C02F 11/04; F04B 17/05; F04B 19/04; F04B 9/02

(52) U.S. Cl. CPC C02F 11/04; F04B 9/02; F04B 17/05; F04B 19/04; C02F 2303/10

(57) ABSTRACT

A system for using biogases produced as a part of the wastewater treatment process is described. The gasses produced during the anaerobic treatment of wastewater are collected, conditioned, optionally compressed, and combusted in an engine designed for the combustion of biogases. Mechanical power produced by the engine is then used to directly power one or more devices used in the wastewater treatment process such as aerators, mixers, compressors, and the like.

### TECHNICAL FIELD

The present novel technology relates generally to blower and air handling systems, and, more particularly, to a method, apparatus and/or kit for utilizing biogas or like bi-products for energizing air handling or other water treatment systems.

### BACKGROUND

In general, anaerobic digestion is a process where microorganisms break down wastes in the absence of oxygen. Wastewater treatment plants utilize anaerobic digestion, post primary and secondary treatment, to stabilize and eliminate remaining biodegradables from sludge. Anaerobic digestion reduces odor and bacteria levels in sludge, leaving it relatively inert. This process can also be utilized as a source of energy due to the production of biogas, which typically consists of a mixture of methane, carbon dioxide, and other trace gases.

An increasing number of the larger waste treatment installations are being designed to feed cogeneration systems. Cogeneration entails the use of biogas to generate electricity and/or heat, both of which are consumed at the waste treatment facility. The generation of electricity requires conditioning of the raw or as-collected biogas to prepare it for use in an internal combustion engine (ICE) driven generator. The generator is connected to the plant power supply to contribute electricity to power blowers, pumps, lights, heating or air conditioning, and the like. The waste heat from the internal combustion engine may be used to heat the anaerobic digester.

While cogeneration laudably makes use of otherwise wasted energy opportunities, cogeneration techniques are still being developed and optimized, and as such have a few drawbacks. One such drawback is that the conditioning of biogas to become suitable for use in an ICE is a complex, potentially hazardous and maintenance intensive process, requiring H₂S, moisture and siloxane removal, as well as a compression step. Siloxanes are especially problematic, as they are polymers found in thousands of products, are released into biogas and precipitate out when the biogas is burned, destructively fouling an ICE. Hydrogen sulfide (H₂S) and siloxane removal are typically accomplished using iron sponge media and activated carbon respectively, which must be changed monthly at a typical cost of between about $10,000 and $50,000 per replacement cycle.

Cogeneration also requires a fairly steep initial investment, typically in the millions of dollars range. This includes the cost of the electrical generator, the electrical system redesign and the cost of power distribution. Further, there is in inherent inefficiency in the transduction from mechanical to electrical energy, wherein usable energy is lost in the transition from engine to generator. This combination of drawbacks makes cogeneration attractive only when energy costs are high and/or government subsidies and incentives are generous.

Thus, there is a need for a cogeneration system exhibiting increased efficiency and/or avoiding one or more of the above-listed drawbacks. The present novel technology addresses these needs.

### BRIEF DESCRIPTION OF THE DRAWINGS

For a better understanding of the nature and objects of the present novel technology, reference should be made to the following drawings, in which:

FIG. 1 is a block diagram illustrating a first example of the present novel technology.

FIG. 2 is a block diagram illustrating a second example of the present novel technology powering a mixer used in a waste water treatment process.

FIG. 3 is a block diagraph illustrating another example of the present novel technology powering optional devices.

FIG. 4 is a block diagram of one example of a biogas conditioning system usable with the present novel technology.

FIG. 5 is a block diagram of another example of the disclosed technology powering process aeration for a water treatment process.

### DESCRIPTION

For the purposes of promoting an understanding of the principles of the novel technology, reference will now be made to the embodiments illustrated in the drawings and specific language will be used to describe the same. It will nevertheless be understood that no limitation of the scope of the novel technology is thereby intended, such alterations and further modifications in the illustrated device, and such further applications of the principles of the novel technology as illustrated therein being contemplated as would normally occur to one skilled in the art to which the novel technology relates.

The present invention relates to an improved energy cogeneration system that foregoes the electrical subsystem investment of classic cogeneration systems and instead directly utilizes the motive power of generated biogas to provide onsite diffused aeration. Since diffused aeration accounts for approximately 60% of the power draw of a typical activated sludge wastewater treatment plant, such systems rarely provide surplus power for sale and instead utilize the power onsite. The improved system increases output power from the biogas use by eliminating two inefficiencies: the mechanical to electrical inefficiency of the generator, and the electrical to mechanical inefficiency of the electric motor used to power an aeration blower. At its most basic level, the system functions by pulling biogas 10 from the anaerobic digester, conditioning 12 the gas for use in a converted low energy density internal combustion engine 14, and directly powering 16 a PD, screw, a multi-stage centrifugal blower, or other device used in the treatment process that has been adapted to be powered directly by an engine. Optionally, mechanical power may be transferred from an engine to a device to be powered through an intermediary device such as a gear box to speed up, slow down, or otherwise modify the strength, speed, torque, or other characteristic(s) of the mechanical power as desired.

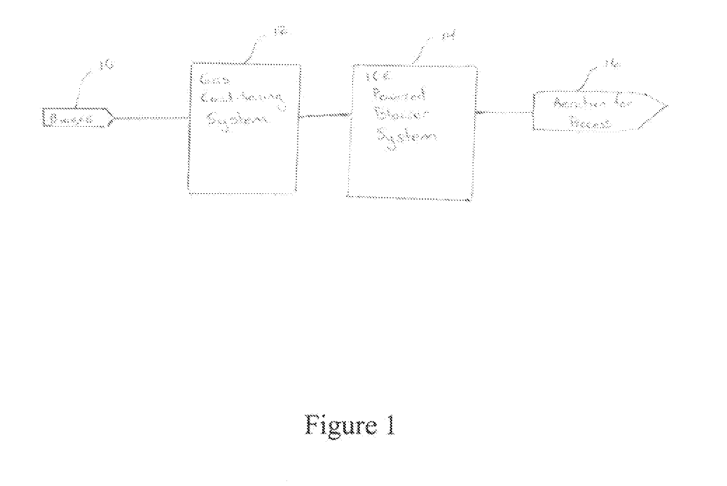

The following examples of the disclosed technology will be described using the basic structure described with respect to FIG. 1. It is understood that one of ordinary skill in the art could adapt the disclosed technology for use with other configurations and that such adaptations are within the scope of the invention. For example, biogas drawn from a digester after conditioning may be combusted in an external combustion engine such as a boiler, a Stirling engine, and the like which is used to drive devices used in the wastewater treatment process. The system may also be adapted for use in conjunction with aerobic or anaerobic digestion systems having more or fewer reaction tanks as the following examples.

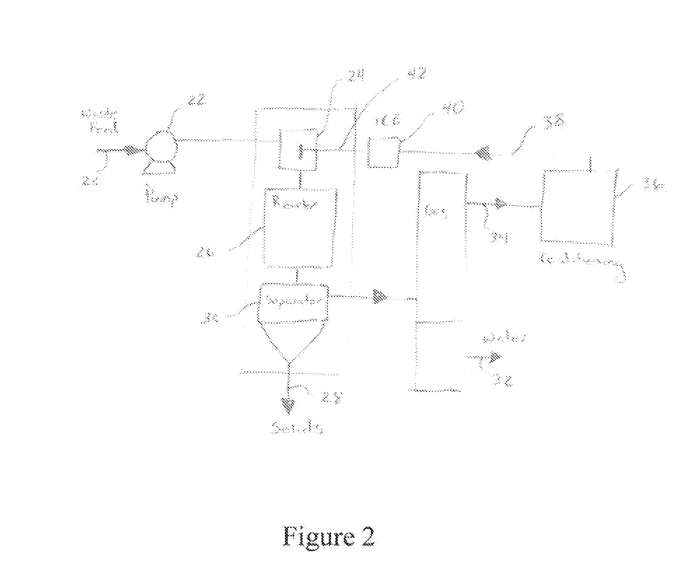

One example of a system according to the disclosed technology is shown in FIG. 2. In this example, waste water 20 to be treated is pumped 22 into a mixing vessel 24 or optionally into a combination mixing vessel and reactor 26. Solids 28 settle out of solution in one or more separation tanks 30, having fixed or movable covers as desired, and are removed. Liquid 32 and gases 34 are separated with liquids 32 being drawn off for further treatment if necessary. Gasses 34 are then conditioned 36 so as to make suitable for combustion. The exact nature of this conditioning will vary according to the process used to treat the wastewater, but typically it will involve particulate, water vapor, hydrogen sulfide, chlorine, and siloxane removal. Once conditioned, the biogas is then piped 38 to one or more internal combustion engines 40 adapted for use with biogas. The exact nature of alterations made to the internal combustion engine will vary, but typically it will at least be modified so as to work with low energy density and/or low pressure biogas.

In a traditional waste water treatment system a blower for aerating and mixing a tank in the treatment process would be driven by an electric motor hooked up to an electrical grid. In a traditional cogeneration system, such a blower would be driven by an electric motor powered by an electrical generator driven by a biogas burning internal combustion engine. In this example of the disclosed technology, an internal combustion engine 40 powered by biogas generated during the water treatment process provides direct mechanical power to a blower/mixer/diffuser 42 used in the mixing tank of the treatment process. Optionally, additional biogas may be used to power other devices used in the treatment process such as additional blowers, mixers, aerators, pumps, and the like.

The combustion of biogas and direct conversion into mechanical energy increases the overall efficiency of the process by allowing more of the energy stored in the biogas to be captured and used. Traditional cogeneration processes involve inefficiency and energy loss inherent in converting the energy of the combusted biogas into electricity, transmission losses inherent in transmitting the electricity to the end use, and losses inherent in converting the electrical energy into mechanical power for driving a particular device.

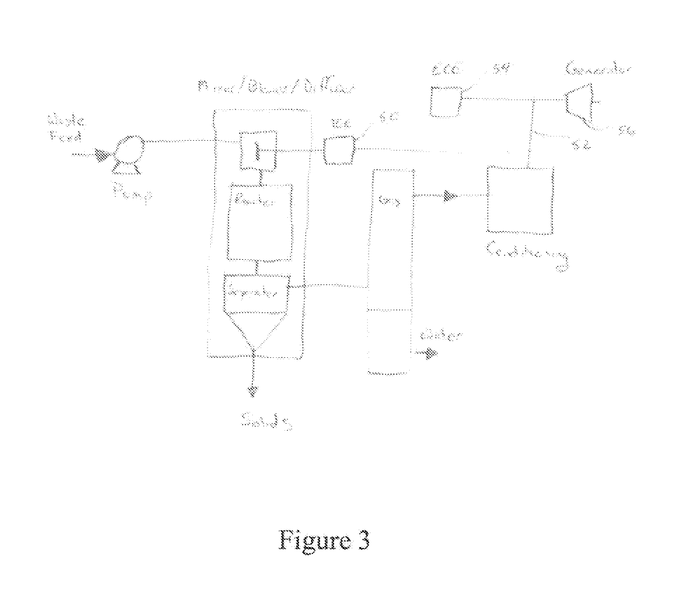

FIG. 3 shows another example of a system according to the disclosed technology. In this particular example, in addition to an internal combustion engine 50 used to directly power a blower, conditioned biogas is piped 52 to be used to power an external combustion engine 54 such as a boiler to provide steam for use in the facility and/or heat, and to power a traditional electrical generator 56 for producing electricity either for use in the treatment facility or for sale via an electrical grid. Different combinations of internal combustion engines, external combustion engines, and electrical generators may be used as desired. Typically each device will be selectively powerable such that devices may be individually brought on or off line as desired. For example, a boiler may only be brought on line during cold months when extra heating of the facility is necessary. An electrical generator may be brought on line when there is sufficient excess biogas which is not being used to run other devices. In most applications there will be insufficient excess biogas to justify the inclusion of an electrical generator, but one can be incorporated into the present system if desired.

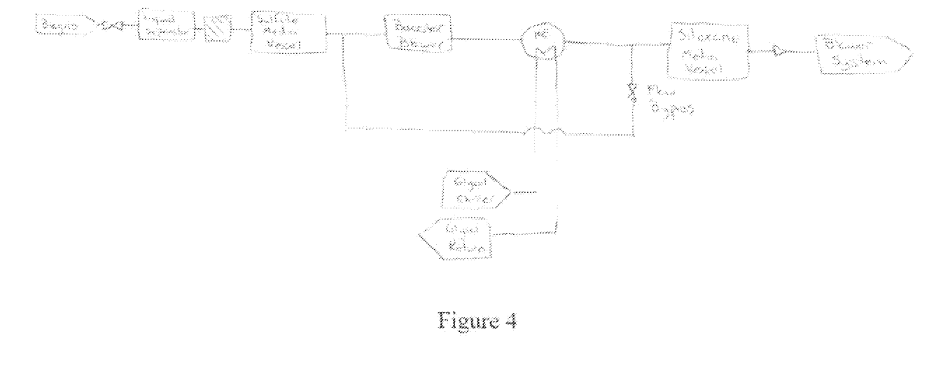

An example of a biogas conditioning system usable as part of the disclosed technology is shown in FIG. 4. The specifics of what sort of biogas conditioning is necessary for safe and efficient combustion of the biogas will vary according to the exact process used in treating wastewater. In this particular example, biogas is filtered and condensation separated from the stream before moving into a sulfa media vessel containing iron sponge media or similar process to accomplish H₂S removal. The gas is then boosted in pressure with a blower or compressor, chilled, and dried. Afterwards, siloxane removal is accomplished through passing the gas through activated carbon or similar process.

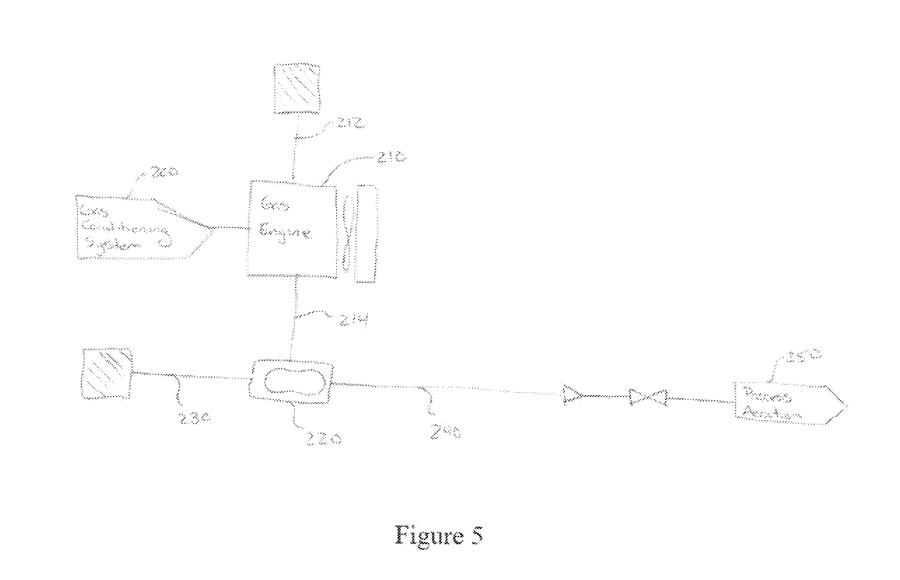

FIG. 5 is a block diagram of one example of the disclosed technology powering process aeration for a water treatment process. In this particular example, conditioned biogas from a suitable conditioning system 200 is piped to an engine 210 designed to combust biogas. Additional fuel, air, or other materials may optionally be piped 212 into the engine as desired. Combustion gases from the engine may be vented to the atmosphere, routed to a mitigation device, or otherwise exhausted as desired. A shaft 214 driven by the engine 210 is used to impart mechanical energy to a compression device 220 such as a rotary compressor, screw-type compressor, or other compressor as desired. The intake gas 230 for the compressor may be drawn from the atmosphere or some other source as desired. The compressed gas is then piped 240 to the wastewater treatment system 250 for aeration and mixing purposes.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

1. A method of powering one or more devices in a wastewater treatment system, comprising:
collecting biogases produced by the wastewater treatment system;
conditioning the collected biogases;
combusting the biogases in an internal combustion engine to produce mechanical power; and
transferring mechanical power directly from the internal combustion engine to at least one water treatment device.

2. The method of claim 1, wherein the at least one water treatment device is selected from the group of: a mixer; a blower; an air compressor; a pump.

3. The method of claim 1, wherein the conditioning step comprises H₂S and siloxane removal.

4. The method of claim 1, wherein the collecting step comprises an anaerobic digester, a cover, and gas delivery piping.

5. The method of claim 1, wherein the mechanical power from the internal combustion engine is transferred to the at least one water treatment device through a gear box.

6. The method of claim 1, wherein the conditioning step includes compressing the biogases to a predetermined pressure.

7. A method of powering devices in a water treatment process, comprising:
generating combustible gases during the water treatment process;
collecting said combustible gases;
conditioning the collected combustible gases;
compressing the conditioned combustible gases;
combusting the combustible gases in an engine to produce mechanical power; and
transferring mechanical power directly from the engine to at least one water treatment device.

8. The method of claim 7, wherein engine is an internal combustion engine.

9. The method of claim 7, wherein engine is an external combustion engine.

10. The method of claim 7, wherein the mechanical power from the engine is transferred to the at least one water treatment device through a gear box.

11. The method of claim 7, wherein the at least one water treatment device is selected from the group of: a mixer; a blower; an air compressor; a pump.

12. The method of claim 7, wherein the conditioning step comprises H₂S and siloxane removal.

13. The method of claim 8, wherein the collecting step comprises an anaerobic digester, a cover, and gas delivery piping.

14. The method of claim 13, wherein the cover is fixed.

15. The method of claim 13, wherein the cover is floating.

16. A method of powering one or more devices in a wastewater treatment system, comprising:
generating combustible gases during a water treatment process;
collecting said combustible gases;
conditioning the collected combustible gases;
compressing the conditioned combustible gases; and
combusting the combustible gases in an engine operably coupled to at least one water treatment device;
wherein mechanical power from the engine directly drives the at least one water treatment device.
